(19) United States
(12) Patent Application Publication
(10) Pub. No.: US 2026/0024780 A1
(43) Pub. Date: Jan. 22, 2026

(54) MEMBRANE ELECTRODE ASSEMBLY

(71) Applicant: TOYOTA JIDOSHA KABUSHIKI KAISHA, Toyota-shi (JP)

(72) Inventors: Shunsuke TAKAHASHI, Susono-shi (JP); Keiichi OKUBO, Susono-shi (JP)

(73) Assignee: TOYOTA JIDOSHA KABUSHIKI KAISHA, Toyota-shi (JP)

(21) Appl. No.: 19/255,133

(22) Filed: Jun. 30, 2025

(30) Foreign Application Priority Data
Jul. 18, 2024 (JP) 2024-114488

(51) Int. Cl. H01M 4/86; H01M 4/92; H01M 8/10; H01M 8/1004

(52) U.S. Cl. CPC H01M 4/8652; H01M 4/8663; H01M 4/926; H01M 8/1004; H01M 2008/1095

(57) ABSTRACT

Provided is a membrane electrode assembly which is excellent in durability and performance. The membrane electrode assembly includes a metal ion selected from the group consisting of cerium ion and manganese ion, and a crown ether compound capable of forming an inclusion compound with the metal ion or a salt thereof. The cathode catalyst layer includes an electrode catalyst and an electrolyte. The electrode catalyst is a metal particle-supported carrier in which metal particles having catalytic activity are supported on a carrier having pores. The carrier has: a pore volume distribution having a peak pore diameter of 2.0 nm or more and 9.0 nm or less in pore diameter; a pore volume of mesopores of 2 nm to 30 nm as 7.5 cc/g or more; and a BET specific surface area of 330 m²/g or more.

### CROSS REFERENCE TO RELATED APPLICATIONS

The present application claims priority from Japanese patent application JP 2024-114488 filed on Jul. 18, 2024, the entire content of which is hereby incorporated by reference into this application.

### BACKGROUND

### Technical Field

The present disclosure relates to a membrane electrode assembly.

### Background Art

A solid polymer fuel cell generally includes a membrane electrode assembly (also referred to as “MEA”). The membrane electrode assembly includes a solid polymer electrolyte membrane as an electrolyte membrane, an anode catalyst layer disposed on one surface of the solid polymer electrolyte membrane, and a cathode catalyst layer disposed on the other surface of the solid polymer electrolyte membrane. The anode catalyst layer functions as a fuel electrode, and the cathode catalyst layer functions as an air electrode. Gas diffusion layers are further disposed to both surfaces of the MEA in some cases, and this configuration is referred to as a membrane electrode gas diffusion layer assembly (also referred to as “MEGA”). Here, in the solid polymer fuel cell, during power generation, hydrogen peroxide (H₂O₂) is generated from water and oxygen, and hydroxyl radicals (·OH) are generated from the hydrogen peroxide in the catalyst layer in some cases. The hydrogen peroxide and the hydroxyl radicals cause deterioration of electrolyte resins, such as ionomer, included in the solid polymer electrolyte membrane and the catalyst layers.

Therefore, there has been proposed a technique to detoxify the hydrogen peroxide radicals generated during power generation of a fuel cell by containing a radical quenching agent, such as cerium ions, in an MEA. Detoxification of hydrogen peroxide radicals is, for example, a reaction from the hydrogen peroxide radicals to water.

For example, Vo Dinh Cong Tinh et al., “Enhancement of oxidative stability of PEM fuel cell by introduction of HO radical scavenger in Nafion ionomer,” Journal of Membrane Science 613 (2020) 118517, which is hereinafter referred to as Non-Patent Literature 1, discloses a membrane-electrode assembly (MEA) in which a coordination complex of a 18-crown-6-ether/cerium ion (CRE/Ce) is embedded in a Nafion ionomer between a catalyst and a membrane. Ce serves to scavenge HO-radicals, and CRE has been described to reduce the cerium ion dissolution from MEA during cell operation (Summaries, and the like.).

### SUMMARY

As described above, Non-Patent Literature 1 discloses an anode catalyst layer containing cerium ions as the radical quenching agent and 18-crown-6-ether. One of the problems of cerium ions is a decrease in durability due to a decrease in concentration due to ion-transfer, but Non-Patent Literature 1 describes that the dissolution of cerium ions out of the MEA can be reduced by adding the 18-crown-6-ether. However, when a large amount of a crown ether compound such as the 18-crown-6-ether is added to the membrane electrode assembly, the deterioration in IV performance under high temperature and low humidification conditions becomes a problem. Therefore, it has been found that there is a room for improving the performance of the membrane electrode assembly including the radical quenching agent such as cerium ions and the crown ether compound such as the 18-crown-6-ether.

Exemplary embodiments relate to providing a membrane electrode assembly which is excellent in durability and performance.

The present inventors have intensively studied to solve the above problems, and found that the reason for the deterioration in the performance is that the crown ether compound contained in the anode catalyst layer or the electrolyte membrane is transferred to the cathode catalyst layer to poison the cathode catalyst, and to decrease the proton conductivity in the ionomer of the cathode. Therefore, the present inventors have further studied and found that by using a carrier having predetermined properties as a carrier for the electrode catalyst in the cathode catalyst layer, it is possible to suppress the poisoning of the catalyst by the crown ether compound, and consequently, it is possible to provide the membrane electrode assembly excellent in durability.

That is, the gist of the present disclosure is as follows.
(1) A membrane electrode assembly comprises a solid polymer electrolyte membrane; an anode catalyst layer disposed on one surface of the solid polymer electrolyte membrane; and a cathode catalyst layer disposed on the other surface of the solid polymer electrolyte membrane. The membrane electrode assembly comprises a metal ion selected from the group consisting of cerium ion and manganese ion, and a crown ether compound capable of forming an inclusion compound with the metal ion or a salt thereof. The cathode catalyst layer comprises an electrode catalyst and an electrolyte. The electrode catalyst is a metal particle-supported carrier in which metal particles having catalytic activity are supported on a carrier having pores. The carrier has: a pore volume distribution having a peak pore diameter of 2.0 nm or more and 9.0 nm or less in pore diameter; a pore volume of mesopores of 2 nm to 30 nm as 7.5 cc/g or more; and a BET specific surface area of 330 m²/g or more.
(2) In the membrane electrode assembly according to (1), the crown ether compound has a cyclic structure having a number of ring members of 15 or more.
(3) In the membrane electrode assembly according to (1) or (2), the crown ether compound has a molecular weight of 300 or more.
(4) In the membrane electrode assembly according to any one of (1) to (3), the crown ether compound has an aromatic ring or an aliphatic ring.
(5) In the membrane electrode assembly according to any one of (1) to (4), the crown ether compound is at least one compound selected from the group consisting of dibenzo-15-crown-5-ether, benzo-18-crown-6-ether, dibenzo-18-crown-6-ether, benzo-21-crown-7-ether, dibenzo-21-crown-7-ether, benzo-24-crown-8-ether, dibenzo-24-crown-8-ether, cyclohexano-18-crown-6-ether, cyclohexano-21-crown-7-ether, cyclohexano-24-crown-8-ether, dicyclohexano-18-crown-6-ether, dicyclohexano-21-crown-7-ether, and dicyclohexano-24-crown-8-ether, and compounds in which an aromatic ring or an aliphatic ring of these compounds is substituted by at least one substituent selected from a halogen atom, a hydroxy group, an amino group, a nitro group, a formyl group, an alkyl group having 1 to 6 carbon atoms, a hydroxyalkyl group having 1 to 6 carbon atoms, a carboxyalkyl group having 2 to 7 carbon atoms, and an aryl group having 6 to 14 carbon atoms.

The present disclosure allows providing the membrane electrode assembly having excellent durability.

### BRIEF DESCRIPTION OF THE DRAWINGS

FIG. 1 is a schematic cross-sectional view for describing an exemplary configuration of a membrane electrode assembly and a solid polymer fuel cell according to the embodiment, and is a cross-sectional view of a main part of an exemplary fuel cell 10.

### DETAILED DESCRIPTION

The embodiment is a membrane electrode assembly comprises a solid polymer electrolyte membrane; an anode catalyst layer disposed on one surface of the solid polymer electrolyte membrane; and a cathode catalyst layer disposed on the other surface of the solid polymer electrolyte membrane. The membrane electrode assembly includes a metal ion selected from the group consisting of cerium ion and manganese ion, and a crown ether compound capable of forming an inclusion compound with the metal ion or a salt thereof. The cathode catalyst layer comprises an electrode catalyst and an electrolyte. The electrode catalyst is a metal particle-supported carrier in which metal particles having catalytic activity are supported on a carrier having pores. The carrier has: a pore volume distribution having a peak pore diameter of 2.0 nm or more and 9.0 nm or less in pore diameter; a pore volume of mesopores of 2 nm to 30 nm that is 7.5 cc/g or more; and a BET specific surface area that is 330 m²/g or more.

The embodiment allows providing the membrane electrode assembly having durability. In the embodiment, cerium ions and/or manganese ions that function as a radical quenching agent are added in the membrane electrode assembly (such as the anode catalyst layer or the solid polymer electrolyte membrane). Since the hydrogen peroxide radicals can be trapped and detoxified by cerium ions and/or manganese ions, the deterioration of the membrane electrode assembly can be suppressed. Additionally, by adding the host compound for the above-described metal ions in the membrane electrode assembly, the movement of the above-described metal ions can be suppressed, reducing the concentration non-uniformity in a planar direction. In this case, the host compound may be the crown ether compound or a salt thereof. Thus, the metal-ion migration inhibition is allowed to be further improved. Further, in the membrane electrode assembly according to the embodiment, the poisoning of the cathode catalyst by the crown ether compound can be suppressed by using the predetermined carrier, and the performance degradation at high loads can be suppressed. For the above reasons, according to the embodiment, the membrane electrode assembly excellent in durability and performance can be provided.

The following describes a configuration of the embodiment.

The solid polymer electrolyte membrane has a function of suppressing the circulation of the electrons and the gases, and transferring the protons (H⁺) generated at the anode from the anode-side catalyst layer to the cathode-side catalyst layer. As the solid polymer electrolyte membrane in the embodiment, an electrolyte membrane having proton conductivity known in the technical field can be used. As the solid polymer electrolyte membrane, for example, a membrane formed of a fluororesin having sulfonic acid group as an electrolyte (such as Nafion (produced by DuPont de Nemours, Inc.), FLEMION (produced by AGC Inc.), and Aciplex (produced by Asahi Kasci Corporation)) can be used.

While a thickness of the solid polymer electrolyte membrane is not particularly limited, it is, for example, 5 μm to 50 μm from the aspect of improvement in the proton conductivity.

The cathode catalyst layer functions as an air electrode (oxygen electrode). The cathode catalyst layer includes at least an electrode catalyst and an electrolyte. In some embodiments, the electrode catalyst is a metal-supported catalyst. In the metal-supported catalyst, a particulate catalyst metal is supported on a carrier. In the present disclosure, a state in which the catalyst is supported on the carrier having pores is a concept including at least one of a state in which the catalyst is supported on a carrier surface and a state in which the catalyst is supported on an inner wall surface inside the pores of the carrier.

As a method of supporting the catalyst metal on the carrier, a method conventionally used can be employed. For example, there is a method in which the catalyst is mixed with a carrier dispersion in which the carrier is dispersed, filtered, washed, redispersed in ethanol or the like, and then dried by a vacuum pump or the like. After drying, as necessary, a heat treatment may be performed.

In the embodiment, a carrier having pores is used as the carrier.

In the carrier used in the embodiment, a pore volume distribution has a peak pore diameter in a range of 2.0 nm or more and 9.0 nm or less in pore diameter. When the peak pore diameter of the pore volume distribution in the carrier is 2.0 nm or more, the catalyst particles can be supported in the pores in some embodiments. When the peak pore diameter of the pore volume distribution in the carrier is 9.0 nm or less, it is possible to suppress the penetration of the ionomer into the carrier pores and to suppress the poisoning of the catalyst by the penetration of the crown ether through the ionomer into the pores in some embodiments.

The peak pore diameter of the pore volume distribution may be 2.5 nm or more, and is 3.0 nm or more in some embodiments. The peak pore diameter of the pore volume distribution may be 8.5 nm or less, 8.0 nm or less, 7.5 nm or less, 7.0 nm or less, 6.5 nm or less, or 6.0 nm or less, and is 5.5 nm or less in some embodiments.

In the carrier used in the embodiment, the pore volume of the mesopores of 2 nm to 30 nm is 7.5 cc/g or more. When the pore volume of the mesopores of 2 nm to 30 nm in the carrier is 7.5 cc/g or more, a sufficient amount of the catalytic particles can be supported in the pores in some embodiments. The upper limit of the pore volume of the mesopores of 2 nm to 30 nm in the carrier is not particularly limited, and is 20.0 cc/g or less from the viewpoint of durability of the carrier in some embodiments.

The pore volume of the mesopores of 2 nm to 30 nm may be 8.0 cc/g or more, 8.5 cc/g or more, 9.0 cc/g or more, or 9.5 cc/g or more, and is 10.0 cc/g or more in some embodiments. The pore volume of the mesopores of 2 nm to 30 nm may be 18.0 cc/g or less or 16.0 cc/g or less, and is 14.0 cc/g or less in some embodiments.

The carrier used in the embodiment has a BET specific surface area of 330 m²/g or more. When the BET specific surface area in the carrier is 330 m²/g or more, a loading ratio can be kept while the particle diameter of the platinum catalyst is suppressed to a small particle diameter, and the pores generated by the voids between the particles can be increased, in some embodiments. The upper limit of the BET specific surface area in the carrier is not particularly limited, and may be 850 m²/g or less from the viewpoint of durability of the carrier.

The BET specific surface area may be 350 m²/g or more or 400 m²/g or more, and is 450 m²/g or more in some embodiments. The BET specific surface area may be 800 m²/g or less and 750 m²/g or less in some embodiments.

The carrier is not particularly limited, and examples thereof include carbon, oxides, and the like. The carbon may be a carbon having electronic conductivity. One kind of the carrier may be used alone, or two or more kinds thereof may be used in combination.

Examples of the carbon carrier include a carbon black (acetylene black, Ketjen black, furnace black, or the like), activated carbon, graphite, glassy carbon, graphene, a carbon fiber, a carbon nanotube, a carbon nitride, a sulfurized carbon, and phosphated carbon. One kind of the carbon carrier may be used alone, or two or more kinds thereof may be used in combination.

Examples of the oxide carrier include titanium oxide, niobium oxide, tin oxide, tungsten oxide, and molybdenum oxide. One kind of the oxide carrier may be used alone, or two or more kinds thereof may be used in combination.

The catalyst metal is not particularly limited as long as it exhibits a catalytic action in the reaction at the electrode.

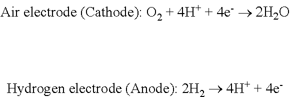

The catalyst metal is not particularly limited, and for example, platinum, palladium, rhodium, gold, silver, osmium, iridium, or an alloy of two or more thereof can be used. Additionally, the platinum alloy is not specifically limited, and, for example, an alloy of platinum and at least one of aluminum, chromium, manganese, iron, cobalt, nickel, gallium, zirconium, molybdenum, ruthenium, rhodium, palladium, vanadium, tungsten, rhenium, osmium, iridium, titanium, and lead can be used. The catalyst metal may be at least one selected from the group consisting of platinum particles, platinum alloy particles, and composite particles containing platinum. One kind of the catalyst metal may be used alone, or two or more kinds thereof may be used in combination.

While the content of the electrode catalyst in the cathode catalyst layer is not particularly limited, for example, the content is 3 mass % to 40 mass % of the total mass of the catalyst layer.

The electrolyte used for the cathode catalyst layer is an ionomer having sulfonate groups in some embodiments. The ionomer is also referred to as cation-exchange resin, and is present as a cluster formed of ionomer molecules. The ionomer is not specifically limited, and, for example, the ionomer known in the technical field can be used. Examples of the ionomer include: fluororesin-based electrolyte, such as perfluorosulfonic acid resin; sulfonated plastic-based electrolyte, such as sulfonated polyether ketone, sulfonated polyethersulfone, sulfonated polyether ether sulfone, sulfonated polysulfone, sulfonated polysulfide, and sulfonated polyphenylene; and sulfoalkylated plastic-based electrolyte, such as sulfoalkylated polyether ether ketone, sulfoalkylated polyethersulfone, sulfoalkylated polyetherethersulfone, sulfoalkylated polysulfone, sulfoalkylated polysulfide, and sulfoalkylated polyphenylene. One electrolyte may be used alone, or two or more electrolytes may be used in combination.

The anode catalyst layer functions as a fuel electrode, that is, a hydrogen electrode.

The anode catalyst layer includes an electrolyte and an electrode catalyst such as ionomers. The ionomer is an ionomer having sulfonic acid group in some embodiments. Examples of the ionomer having sulfonic acid group include those described above. In one embodiment, the anode catalyst layer may include, in addition to the electrode catalyst and the ionomer, a metal ion selected from cerium ion and manganese ion, and the crown ether compound capable of forming an inclusion compound with the metal ions.

While the electrode catalyst is not particularly limited, for example, the above-described materials can be used.

While the ionomer having sulfonic acid group is not specifically limited, examples thereof include a polymer electrolyte resin having ionic conductivity, such as a perfluorosulfonic acid ionomer. Specific examples of the ionomer having sulfonic acid group include Nafion and Aquivion (Solvay S.A.).

The membrane electrode assembly according to the embodiment includes a metal ion selected from cerium ion and manganese ion, and the crown ether compound capable of forming an inclusion compound with the metal ions or a salt thereof (host compound). Since cerium ions and/or manganese ions function as a radical quenching agent and can trap and detoxify the hydrogen peroxide radicals, the deterioration of the membrane electrode assembly can be suppressed. In addition, by adding the crown ether compound, which is a host compound to the metal ions, to the membrane electrode assembly, the movement of the metal ions can be suppressed, and the concentration non-uniformity in the plane can be reduced.

The metal ions are selected from cerium ions and manganese ions. The cerium ions and the manganese ions function as a radical quenching agent. The radical quenching agent can facilitate the transformation of the hydroxyl radical generated from the hydrogen peroxide into hydroxide ion, and can suppress the deterioration of the anode catalyst layer. For example, the reaction of the hydroxyl radicals to the hydroxide ions by the cerium ions is as follows.

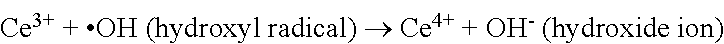

The cerium ions may be positive trivalent ions or may be positive quadrivalent ions. The manganese ions may be positive trivalent ions or may be positive quadrivalent ions.

While a cerium salt for obtaining the cerium ions is not particularly limited, examples of the cerium salt include cerium nitrate, cerium carbonate, cerium acetate, cerium chloride, ceric sulfate, diammonium cerium nitrate, or tetraammonium cerium sulfate. One kind of the cerium salt may be used alone, or two or more kinds thereof may be used in combination. The cerium salt may be an organometallic complex salt. Examples of the organometallic complex salt include, for example, cerium acetylacetonate.

While a manganese salt for obtaining the manganese ions is not particularly limited, examples of the manganese salt include manganese nitrate, manganese carbonate, manganese acetate, manganese chloride, manganese sulfate, or the like. One kind of the manganese salt may be used alone, or two or more kinds thereof may be used in combination.

The crown ether compound or a salt thereof as a host compound in the embodiment forms an inclusion compound with cerium ions or manganese ions as a guest compound. The inclusion compound means an addition compound having a configuration in which the above-described metal ions as the guest compound are included in the host compound. One kind of the crown ether compound may be used alone, or two or more kinds thereof may be used in combination.

The crown ether compound has a cyclic structure, but the number of ring members of the cyclic structure may be 15 or more, and is 18 or more in some embodiments. The crown ether compound is a compound having a ring having a repeating configuration of a (—CH₂—CH₂—Y—) unit or a (—CH₂—CH₂—CH₂—Y—) unit, and Y is at least one heteroatom selected from O, S, N, and P. The crown ether compound traps metal ions in the ring to form an inclusion compound. The number of ring members of the crown ether compound may be 15 or more, and is 18 or more in some embodiments.

In the embodiment, the crown ether compound may be a compound having a molecular weight of 300 or more. By using the crown ether compound having a molecular weight of 300 or more, the migration inhibition can be obtained, that is, the migration of the crown ether compound from the anode catalyst layer or the electrolyte membrane to the cathode catalyst layer can be suppressed.

Examples of the crown ether compound include crown ether or a crown ether derivative. Examples of the crown ether having the molecular weight of 300 or more include 21-crown-7-ether and 24-crown-8-ether. In this embodiment, the crown ether compound is a crown ether compound having an aromatic ring or an aliphatic ring in some embodiments. The crown ether compound having the aromatic ring or the aliphatic ring has high hydrophobicity caused by its structure, and therefore is excellent in transfer suppression effect. Examples of the crown ether compound having the aromatic ring or the aliphatic ring include dibenzo-15-crown-5-ether, benzo-18-crown-6-ether, dibenzo-18-crown-6-ether, benzo-21-crown-7-ether, dibenzo-21-crown-7-ether, benzo-24-crown-8-ether, dibenzo-24-crown-8-ether, cyclohexano-18-crown-6-ether, cyclohexano-21-crown-7-ether, cyclohexano-24-crown-8-ether, dicyclohexano-18-crown-6-ether, dicyclohexano-21-crown-7-ether, dicyclohexano-24-crown-8-ether, and compounds in which an aromatic ring or an aliphatic ring of these compounds is substituted by at least one substituent selected from a halogen atom (such as a fluorine atom or a bromine atom), a hydroxy group, an amino group, a nitro group, a formyl group, an alkyl group having 1 to 6 carbon atoms (for example, a methyl group, an ethyl group, a propyl group, and a butyl group), a hydroxyalkyl group having 1 to 6 carbon atoms, a carboxyalkyl group having 2 to 7 carbon atoms, and an aryl group having 6 to 14 carbon atoms (for example, a phenyl group). The number of substituents is, for example, from 1 to 6, from 1 to 5, from 1 to 4, from 1 to 3, 1 or 2, or 1. One of the compounds may be used alone, or two or more the compounds may be used in combination.

In the anode catalyst layer in the membrane electrode assembly of the embodiment, at least some of the crown ether compound and the metal ions form an inclusion compound.

Examples of the salt of the crown ether compound include nitrates, sulfates, carbonates, acetates, and propionates. One kind of the salt may be used alone, or two or more kinds thereof may be used in combination.

The crown ether compound and the metal ions can be contained in the anode catalyst layer, the solid polymer electrolyte membrane, or both.

When the anode catalyst layer contains the crown ether compound and a metal ion, the anode catalyst layer includes at least the electrode catalyst, electrolyte, the metal ion selected from cerium ion and manganese ion, and the metal ion and the crown ether compound. The metal ions can facilitate the transformation of the hydroxyl radical generated from hydrogen peroxide into hydroxide ions, and can suppress the deterioration of the anode catalyst layer.

In the anode catalyst layer, the content of the metal ions and the crown ether compound may be 0.1 to 20 mass % based on the total solid content of the anode catalyst layer. Inclusion compounds are regarded as mixtures of the metal ions and the crown ether compound with respect to the content. In other words, when the metal ions and the crown ether compound are added separately or simply mixed and added into the anode catalyst layer, only the total amount of the metal ions and the crown ether compound is calculated without considering the amount of the inclusion compound even when it is formed in the polymer electrolyte. In addition, when the inclusion compound is added to the anode catalyst layer after the inclusion compound is formed in advance, the amount of the inclusion compound is defined as the sum of the metal ions and the crown ether compound forming the inclusion compound. Furthermore, in addition to the metal ions and the crown ether compound forming the inclusion compound, when the metal ions and the crown ether compound not forming the inclusion compound are present, they are also to be calculated.

For the relative ratio of the crown ether compound to the above-described metal ions in the embodiment, the mole ratio of the crown ether compound to the above-described metal ions ([number of moles of crown ether compound] /[number of moles of metal ions]) may be, for example, 0.1 to 10, is 0.2 to 7.5 in some embodiments, and may be 0.4 to 5.0. That is, the content of the crown ether compound with respect to 1 mole of the above-described metal ions is, for example, 0.1 moles to 10 moles, is 0.2 moles to 7.5 moles in some embodiments, and may be 0.4 moles to 5.0 moles in some embodiments. Similarly to the above, the inclusion compound is regarded as a mixture of both of them also in the relative ratio.

When the solid polymer electrolyte membrane contains the crown ether compound and the metal ions, the solid polymer electrolyte membrane that contains the crown ether compound and the metal ions can be obtained by, for example, the following methods.
(1) After a solid polymer electrolyte membrane is immersed in a solution containing metal ions to exchange ions of groups, such as a sulfonate group, with the metal ions, the solid polymer electrolyte membrane is immersed in a solution containing a crown ether compound such that the crown ether compound is included in the membrane.
(2) A method of producing a membrane by coating using a liquid obtained as follows. After a compound containing metal ions (such as cerium salt) is added in a dispersion liquid of polymer electrolytes to exchange ions of groups, such as a sulfonate group, with the metal ions, a solution or solid containing a crown ether compound is added to the dispersion liquid to obtain the liquid.
(3) A method in which a compound containing metal ions (such as cerium salt) and a crown ether compound are caused to react in a solvent to form an inclusion compound, and next, a solid polymer electrolyte membrane is immersed in a solution in which the inclusion compound is dissolved in the solvent to exchange ions of groups, such as a sulfonate group, with the inclusion compound such that the inclusion compound is included in the membrane.
(4) A compound comprising metal ions (such as cerium salt) and a crown ether compound are caused to react in a solvent to form an inclusion compound. Next, the inclusion compound or its solution is added in a dispersion liquid of polymer electrolytes to obtain a liquid. A membrane is produced by coating using the obtained liquid.

### [Method for Manufacturing Membrane Electrode Assembly]

A catalyst layer can be formed by, for example, a process of preparing a catalyst ink (for example, a solid content concentration of about 10%) including an electrode catalyst, an ionomer, and a solvent, a process of applying the catalyst ink over a substrate surface and volatilizing the solvent in the coating film to form a catalyst layer on the substrate surface, and a process of transferring the catalyst layer on the substrate surface to an electrolyte membrane. In addition, a catalyst layer can be formed by a method of directly applying the catalyst ink over a solid polymer electrolyte membrane instead of the substrate. By forming a cathode catalyst layer and an anode catalyst layer on the solid polymer electrolyte membrane, a membrane electrode assembly can be produced.

Examples of a method for applying the catalyst ink include, for example, a spray method, a blade coating method using a doctor blade or an applicator, a die coating method, a reverse roll coater method, and an intermittent die coating method.

For the anode catalyst layer, the above-described metal ions and the above-described crown ether compound may be contained in a catalyst ink for forming the anode catalyst layer. Specifically, the catalyst ink for forming the anode catalyst layer can include an electrode catalyst, an ionomer (for example, an ionomer having a sulfonate group), the above-described metal ions, the crown ether compound, and a solvent. The above-described metal ions and crown ether compound may be each added separately or may be added in a form of a complex of both.

### [Specific Configurations of Membrane Electrode Assembly and Solid Polymer Fuel Cell]

The basic unit of a solid polymer fuel cell is a membrane electrode assembly (MEA) in which catalyst layers (electrodes) are assembled to both surfaces of a solid polymer electrolyte membrane. In the solid polymer fuel cell, gas diffusion layers are generally disposed on external sides of the catalyst layers. The gas diffusion layers are for supplying a reaction gas and electrons to the catalyst layers, and carbon paper, carbon cloth, and the like are used. The catalyst layers are portions that become reaction fields of an electrode reaction.

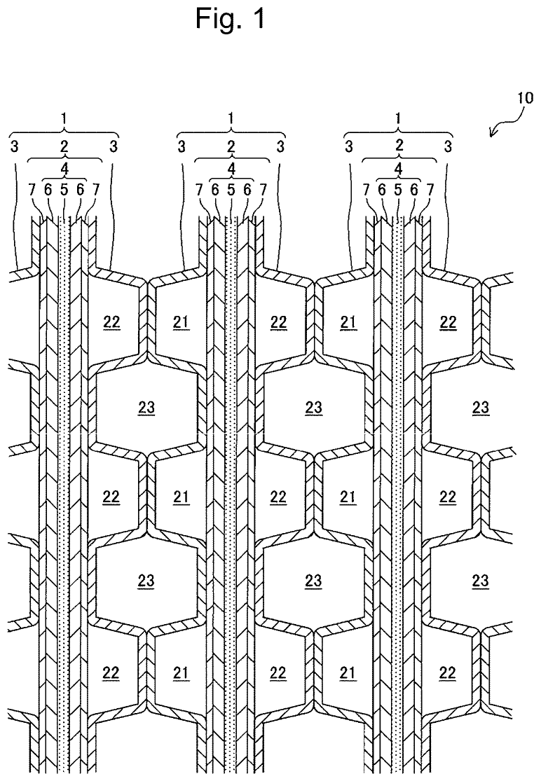

The following describes the configurations of the membrane electrode assembly and the solid polymer fuel cell with reference to FIG. 1. FIG. 1 is a schematic cross-sectional view for describing an exemplary configuration of the solid polymer fuel cell according to the embodiment and cross-sectional view of a main part of an exemplary fuel cell 10. The solid polymer fuel cell includes a stacked body of unit cells constituted of an electricity generating body and fuel cell separators disposed on both surfaces of the electricity generating body. The plurality of unit cells are stacked in a stacking direction, and the respective unit cells are electrically connected in series. As illustrated in FIG. 1, in the fuel cell 10, a plurality of unit cells 1 as a basic unit are stacked. Each unit cell 1 is a solid polymer fuel cell that generates an electromotive force by an electrochemical reaction between an oxidant gas (such as air) and a fuel gas (such as hydrogen). The unit cell 1 includes a membrane electrode gas diffusion layer assembly (MEGA) 2 and separators 3 in contact with the MEGA 2 so as to partition the MEGA 2. On both sides of the MEGA 2, gas diffusion layers (GDL) 7 are disposed. In the embodiment, the MEGA 2 are sandwiched by a pair of separators 3, 3.

The MEGA 2 includes a membrane electrode assembly (MEA) 4 and gas diffusion layers 7, 7 disposed on both surfaces of the membrane electrode assembly 4. The membrane electrode assembly 4 is constituted of an electrolyte membrane 5 and a pair of electrodes 6, 6 assembled to sandwich the electrolyte membrane 5. The electrolyte membrane 5 is, for example, a proton-conductive ion exchange membrane formed of a solid polymer material. The electrode 6 includes, for example, a porous carbon material supporting a catalyst, such as platinum. The electrode 6 disposed on one side of the electrolyte membrane 5 functions as an anode, and the electrode 6 on the other side functions as a cathode. The gas diffusion layer 7 is formed of a conductive member having gas permeability. Examples of the conductive member having gas permeability include, for example, a carbon porous body, such as carbon paper or carbon cloth, or a metal porous body, such as metal mesh or foam metal. In the embodiment, the anode electrode is constituted of an anode catalyst layer, and the cathode electrode is constituted of a cathode catalyst layer.

### EXAMPLES

The following describes the embodiment using examples.

### Method for Evaluating Peak Pore Diameter of Carrier, Pore Volume of Mesopore of 2 nm to 30 nm, and BET Specific Surface Area

The peak pore diameter, the pore volume of 2 nm to 30 nm mesopores, and the BET specific surface area are all measured by a nitrogen adsorption method. From the relative pressure dependence of the amount of nitrogen adsorption on the sample, these three characteristic values can be measured. The BET theoretical method is used to calculate the BET surface area. The mesopores can be measured by a common nitrogen adsorption method at a liquid nitrogen temperature. The peak pore diameter is the pore diameter when the pore volume distribution shows a peak. Further, by analyzing the measurement result obtained by the nitrogen adsorption method, it is possible to obtain the value of the pore volume of the mesopores. For example, the following method can be used for the analysis.

Specifically, the desorption process can be analyzed by Barret-Joyner-Halenda method (Journal of the American Chemical Society, 1951, pages 373 to 380), and the pore volume of the pores belonging to the mesopores of 2 nm to 30 nm can be obtained, for example, by integrating the amount of desorption of nitrogen gas in which the pore diameter corresponds to 2 nm to 30 nm.

### [Example 1] (Formation of Cathode Catalyst Layer)

A platinum-supported catalyst B containing Pt particles as a catalyst metal and carbon black as a carrier on which the metal particles were supported (metal-supported ratio 46 wt %) was prepared. For the carrier, the peak pore diameter was 8.6 nm, the mesopore volume of 2 to 30 nm was 7.6 cc/g, and the BET specific surface area was 336.5 m²/g.

A catalyst ink was prepared by dispersing the electrode catalyst (the platinum-supported catalyst) in an ionomer solution (Nafion DE2020) containing water and ethanol using a bead mill. The water/alcohol weight fraction in the catalyst ink was about 1. The catalyst ink was coated and dried on a polytetrafluoroethylene sheet to form a cathode catalyst layer.

Pt loading amount of the cathode catalyst layer was 0.2 mg/cm², and the weight-ratio (I/C) of the ionomer to the carrier was 1.0.

### (Forming a Complex (Ce-Ligand))

To a 100 mL eggplant flask, benzo-18-crown-6-ether (also referred to as B18CRE) (3.12 g, 0.01 mol) and cerium (III) nitrate hexahydrate (4.34g, 0.01 mol) were measured, ethanol (20 mL) and water (20 mL) were added, and the mixture was stirred at room temperature for 24 hours. After that, the solution was removed by an evaporator, followed by vacuum drying at 60° C. for 1 hour to obtain a white solid. FT-IR confirmed that the peaks derived from the ether groups shifted in low wave number, and that the crown ether compound included Ce. The ligands (the crown ether compound) of the other test examples were also added in a molar ratio of 1:1 to cerium nitrate hexahydrate by the above-described method.

### (Formation of Anode Catalyst Layer)

As the electrode catalyst, a platinum-supported carbon catalyst (TEC10E30E, 30% platinum-supported carbon, produced by Tanaka Kikinzoku Kogyo) was used. The electrode catalyst and the complex were dispersed in an ionomer solution (DE2020) containing water, ethanol, and Nafion (Registered trademark), to prepare the catalyst ink. The catalyst ink was coated over a polytetrafluoroethylene sheet and dried to form an anode catalyst layer.

Pt loading amount of the anode catalyst layer was 0.1 mg/cm², and the cerium ion level was 6 μg/cm². The crown ether compound is added in a molar ratio of Ce:ligand=1:1 according to the above procedure. The concentration of the crown ether compound was 13.5 μg/cm². The weight fraction (I/C) of the ionomer to the carbon was 1.0.

### (Production of Membrane Electrode Assembly)

The obtained cathode catalyst layer and anode catalyst layer were heat-transferred to both respective surfaces of a Nafion (registered trademark) membrane (NR211) to produce a membrane electrode assembly El. A thermal transfer was performed at 140° C., 50 kgf/cm² (4.90 MPa), and 5 min. The membrane electrode assembly has an electrode area for the initial performance test was 1 cm×1 cm (1 cm²). The membrane electrode assembly has an electrode area for durability test was 3.6 cm×3.6 cm (12.96 cm²). The membrane electrode assembly was sandwiched by paper diffusion layers (GDL) with water-repellent layers to produce a test cell.

### Example 2

A platinum-supported catalyst C containing Pt particles as a catalyst metal and carbon black as a carrier on which the metal particles were supported (Ketjen Black EC300J, produced by Lion Specialty Chemicals Co., Ltd., metal loading ratio 42 wt %) was prepared. For the carrier, the peak pore diameter was 5.4 nm, and the mesopore volume of 2 to 30 nm was 10.5 cc/g, and the BET specific surface area was 458.0 m²/g.

A membrane electrode assembly E2 was prepared and evaluated in the same manner as in Example 1, except that the obtained electrode catalyst was used.

### Example 3

A platinum-supported catalyst D containing Pt particles as a catalyst metal and carbon black as a carrier on which the metal particles were supported (metal-supported ratio 48 wt %) was prepared. For the carrier, the peak pore diameter was 3.5 nm, and the mesopore volume of 2 to 30 nm was 14.0 cc/g, and the BET specific surface area was 708.0 m²/g in.

A membrane electrode assembly E3 was prepared and evaluated in the same manner as in Example 1, except that the obtained electrode catalyst was used.

### Comparative Example 1

A platinum-supported catalyst A containing PtCo particles as a catalyst metal and carbon black as a carrier on which the metal particles were supported (metal-supported ratio, 36 wt %, produced by VULCAN, Cabot Co., Ltd.) was prepared. For the carrier, the peak pore diameter was 11.5 nm, and the mesopore volume of 2 to 30 nm was 1.9 cc/g, and the BET specific surface area was 159.0 m²/g.

A membrane electrode assembly C1 was prepared and evaluated in the same manner as in Example 1, except that the obtained electrode catalyst (carbon carrier: VULCAN) was used and cerium(III)nitrate hexahydrate was added instead of the complex added to the anode catalyst layer.

### Comparative Example 2

A membrane electrode assembly C2 was prepared and evaluated in the same manner as in Example 1, except that the electrode catalyst (carbon carrier: VULCAN) obtained in Comparative Example 1 was used.

### Comparative Example 3

A membrane electrode assembly C3 was prepared and evaluated in the same manner as in Example 1, except that cerium (III) nitrate hexahydrate was added instead of the complex added to the anode catalyst layer.

### Comparative Example 4

A membrane electrode assembly C4 was prepared and evaluated in the same manner as in Example 2, except that cerium (III) nitrate hexahydrate was added instead of the complex added to anode catalyst layer.

### Comparative Example 5

A membrane electrode assembly C5 was prepared and evaluated in the same manner as in Example 3, except that cerium (III) nitrate hexahydrate was added instead of the complex added to the anode catalyst layer.

### Example 4

A membrane electrode assembly E4 was prepared and evaluated in the same manner as in Example 3, except that B18CRE was doubled (6.24g, 0.02 mol) at the time of complexation.

### Example 5

A membrane electrode assembly E5 was prepared and evaluated in the same manner as in Example 1, except that 18-crown-6-ether (also referred to as 18CRE) was used instead of benzo-18-crown-6-ether.

### Example 6

A membrane electrode assembly E6 was prepared and evaluated in the same manner as in Example 2, except that 18-crown-6-ether was used instead of benzo-18-crown-6-ether.

### Example 7

A membrane electrode assembly E7 was prepared and evaluated in the same manner as in Example 3, except that 18-crown-6-ether was used instead of benzo-18-crown-6-ether.

### Comparative Example 6

A membrane electrode assembly C6 was prepared and evaluated in the same manner as in Example 5, except that the electrode catalyst (carbon carrier: VULCAN) obtained in Comparative Example 1 was used.

### [Evaluation] (Initial Performance Test)

Cell evaluations were performed using the membrane electrode assembly (Electrode Area: 1 cm²) for early performance testing. The current-voltage properties were evaluated under low humidification conditions (95° C., 30% RH) and the performance (voltage) in 1.5 A/cm² was measured. The sweep rate in evaluating the current-voltage properties was 20 mA/s and obtained by anodic sweep. The cell pressure was 150 kPa, the cathode gas species was air, and the cathode gas flow rate was 2.0 L/min. The results are given in Table 1.

### (Durability Test: Voltage Decrease Rate)

The above-described test cells (electrode area: 12.96 cm²) were incorporated in a cell for power generation to conduct the durability test under a low-humidify environment (90° C., 40% RH). In the durability test, the initial characteristics of the solid polymer fuel cell and the characteristics after the durability test load were evaluated at a cell temperature of 90° C., with hydrogen/air supplied, and at a current density of 0.2 A/cm². Hydrogen and air were each supplied into a cell and humidified so as to have a dew point of 67° C. on the anode side and a dew point of 67° C. on the cathode side, and the cell voltage at the beginning of operation and the relationship between an elapsed time after starting the operation and the cell voltage were measured. The results are shown in Table 1 below. Under the above-described cell evaluation conditions, the cell voltage at the beginning of the operation and the cell voltage after a lapse of 300 hours after starting the operation were measured. The results are shown in Table 1 below.

TABLE 1

| | | | Comparative | Comparative | Comparative | | Comparative | | Comparative |
|---|---|---|---|---|---|---|---|---|---|
| | | | Example 1 | Example 2 | Example 3 | Example 1 | Example 4 | Example 2 | Example 5 |
| Anode | Crown | B18CRE | — | B18CRE | — | B18CRE | — | B18CRE | — |
| catalyst | ether | | | (13.5 ug/cm2) | | (13.5 ug/cm2) | | (13.5 ug/cm2) | |
| layer | | 18CRE | — | — | — | — | — | — | — |
| | Cerium | Ce | 6 g/cm2 | 6 g/cm2 | 6 g/cm2 | 6 g/cm2 | 6 g/cm2 | 6 g/cm2 | 6 g/cm2 |
| | nitrate | | | | | | | | |
| Cathode | Platinum | Type | Platinum | Platinum | Platinum | Platinum | Platinum | Platinum | Platinum |
| catalyst | supported | | supported | supported | supported | supported | supported | supported | supported |
| layer | catalyst | | catalyst A | catalyst A | catalyst B | catalyst B | catalyst C | catalyst C | catalyst D |
| | | Peak pore | 11.5 | 11.5 | 8.6 | 8.6 | 5.4 | 5.4 | 3.5 |
| | | diameter | | | | | | | |
| | | 2 to 30 nm | 1.9 | 1.9 | 7.6 | 7.6 | 10.5 | 10.5 | 14.0 |
| | | pore | | | | | | | |
| | | volume | | | | | | | |
| | | BET | 159.0 | 159.0 | 336.5 | 336.5 | 458.0 | 458.0 | 708.0 |
| | | specific | | | | | | | |
| | | surface | | | | | | | |
| | | area | | | | | | | |
| Initial | Initial | 95° C., | 459 | 423 | 572 | 565 | 546 | 545 | 595 |
| perfor- | voltage | 30% RH, | | | | | | | |
| mance | mV | 1.5 A/cm2 | | | | | | | |
| | Differential | CRE | — | −36 | — | −7 | — | −1 | — |
| | mV of | added − | | | | | | | |
| | initial | CRE not | | | | | | | |
| | voltage | added | | | | | | | |
| Dura- | Voltage mV | 95° C., | 402 | 398 | 513 | 542 | 472 | 521 | 522 |
| bility | after | 30% RH, | | | | | | | |
| | endurance | 1.5 A/cm2 | | | | | | | |
| | (300 hours) | | | | | | | | |
| | Voltage | | 87.6% | 94.1% | 89.7% | 95.9% | 86.4% | 95.6% | 87.7% |
| | retention % | | | | | | | | |

| | | | | | Comparative | | | |
|---|---|---|---|---|---|---|---|---|
| | | | Example 3 | Example 4 | Example 6 | Example 5 | Example 6 | Example 7 |
| Anode | Crown | B18CRE | B18CRE | B18CRE | — | — | — | — |
| catalyst | ether | | (13.5 ug/cm2) | (27.0 ug/cm2) | | | | |
| layer | | 18CRE | — | — | 18CRE | 18CRE | 18CRE | 18CRE |
| | | | | | (11.4 ug/cm2) | (11.4 ug/cm2) | (11.4 ug/cm2) | (11.4 ug/cm2) |
| | Cerium | Ce | 6 g/cm2 | 6 g/cm2 | 6 g/cm2 | 6 g/cm2 | 6 g/cm2 | 6 g/cm2 |
| | nitrate | | | | | | | |
| Cathode | Platinum | Type | Platinum | Platinum | Platinum | Platinum | Platinum | Platinum |
| catalyst | supported | | supported | supported | supported | supported | supported | supported |
| layer | catalyst | | catalyst D | catalyst D | catalyst A | catalyst B | catalyst C | catalyst D |
| | | Peak pore | 3.5 | 3.5 | 11.5 | 8.8 | 5.4 | 3.5 |
| | | diameter | | | | | | |
| | | 2 to 30 nm | 14.0 | 14.0 | 1.9 | 7.6 | 10.5 | 14.0 |
| | | pore | | | | | | |
| | | volume | | | | | | |
| | | BET | 708.0 | 708.0 | 159.0 | 336.5 | 458.0 | 708.0 |
| | | specific | | | | | | |
| | | surface | | | | | | |
| | | area | | | | | | |
| Initial | Initial | 95° C., | 596 | 592 | 407 | 557 | 544 | 593 |
| perfor- | voltage | 30% RH, | | | | | | |
| mance | mV | 1.5 A/cm2 | | | | | | |
| | Differential | CRE | 1 | −3 | −52 | −15 | −2 | −2 |
| | mV of | added − | | | | | | |
| | initial | CRE not | | | | | | |
| | voltage | added | | | | | | |
| Dura- | Voltage mV | 95° C., | 576 | 574 | 392 | 538 | 519 | 570 |
| bility | after | 30% RH, | | | | | | |
| | endurance | 1.5 A/cm2 | | | | | | |
| | (300 hours) | | | | | | | |
| | Voltage | | 96.6% | 97.0% | 96.3% | 96.6% | 95.4% | 96.1% |
| | retention % | | | | | | | |

Upper limit values and/or lower limit values of respective numerical ranges described in the present specification can be appropriately combined to specify an appropriate range. For example, upper limit values and lower limit values of the numerical ranges can be appropriately combined to specify an appropriate range, upper limit values of the numerical ranges can be appropriately combined to specify an appropriate range, and lower limit values of the numerical ranges can be appropriately combined to specify an appropriate range.

While the embodiment has been described in detail, the specific configuration is not limited to the embodiment. Design changes within a scope not departing from the gist of the present disclosure are included in the present disclosure.

All publications, patents and patent applications cited in the present description are herein incorporated by reference as they are.

What is claimed is:

1. A membrane electrode assembly comprising:
a solid polymer electrolyte membrane;
an anode catalyst layer disposed on one surface of the solid polymer electrolyte membrane; and
a cathode catalyst layer disposed on the other surface of the solid polymer electrolyte membrane,
wherein the membrane electrode assembly comprises a metal ion selected from the group consisting of cerium ion and manganese ion, and a crown ether compound capable of forming an inclusion compound with the metal ion or a salt thereof,
the cathode catalyst layer comprises an electrode catalyst and an electrolyte,
the electrode catalyst is a metal particle-supported carrier in which metal particles having catalytic activity are supported on a carrier having pores,
the carrier has:
a pore volume distribution having a peak pore diameter of 2.0 nm or more and 9.0 nm or less in pore diameter;
a pore volume of mesopores of 2 nm to 30 nm as 7.5 cc/g or more; and
a BET specific surface area of 330 m²/g or more.

2. The membrane electrode assembly according to claim 1,
wherein a number of ring members of a ring structure of the crown ether compound is 15 or more.

3. The membrane electrode assembly according to claim 1,
wherein the crown ether compound has a molecular weight of 300 or more.

4. The membrane electrode assembly according to claim 1,
wherein the crown ether compound has an aromatic ring or an aliphatic ring.

5. The membrane electrode assembly according to claim 1,
wherein the crown ether compound is at least one compound selected from the group consisting of dibenzo-15-crown-5-ether, benzo-18-crown-6-ether, dibenzo-18-crown-6-ether, benzo-21-crown-7-ether, dibenzo-21-crown-7-ether, benzo-24-crown-8-ether, dibenzo-24-crown-8-ether, cyclohexano-18-crown-6-ether, cyclohexano-21-crown-7-ether, cyclohexano-24-crown-8-ether, dicyclohexano-18-crown-6-ether, dicyclohexano-21-crown-7-ether, and dicyclohexano-24-crown-8-ether, and compounds in which an aromatic ring or an aliphatic ring of these compounds is substituted by at least one substituent selected from a halogen atom, a hydroxy group, an amino group, a nitro group, a formyl group, an alkyl group having 1 to 6 carbon atoms, a hydroxyalkyl group having 1 to 6 carbon atoms, a carboxyalkyl group having 2 to 7 carbon atoms, and an aryl group having 6 to 14 carbon atoms.
